(19) United States
(12) Patent Application Publication
(10) Pub. No.: US 2013/0048624 A1
(43) Pub. Date: Feb. 28, 2013

(54) PRESSURE-SENSITIVE ADHESIVE STRENGTH EXHIBITING UNIT, PRESSURE-SENSITIVE ADHESIVE LABEL ISSUING DEVICE, AND PRINTER

(71) Applicants: Yoshinori Sato, Chiba-shi (JP); Kazuo Tani, Chiba-shi (JP); Norimitsu Sanbongi, Chiba-shi (JP)

(72) Inventors: Yoshinori Sato, Chiba-shi (JP); Kazuo Tani, Chiba-shi (JP); Norimitsu Sanbongi, Chiba-shi (JP)

(21) Appl. No.: 13/590,587

(22) Filed: Aug. 21, 2012

(30) Foreign Application Priority Data
Aug. 23, 2011 (JP) 2011-181937

(51) Int. Cl. H05B 1/02; H05B 3/06; H05B 3/02

(52) U.S. Cl. 219/470; 219/483; 219/488; 219/489; 219/494; 219/201

(57) ABSTRACT

A pressure-sensitive adhesive strength exhibiting unit including: a thermal head including heat-generating elements aligned in a row, for heating the pressure-sensitive adhesive label from the pressure-sensitive adhesive layer side to cause each of the heat-generating elements to form a bore in the functional layer; a platen roller for conveying the pressure-sensitive adhesive label while sandwiching the pressure-sensitive adhesive label between the thermal head and the platen roller; and a control part for applying heat energy to each of the heat-generating elements independently, wherein when the control part continuously forms perforation lines in which a plurality of the bores are aligned in a row by repeating the application of heat energy, the control part applies high heat energy, whose energy amount is higher than an energy amount of heat energy applied to the heat-generating elements during formation of a previous perforation line, to the heat-generating elements to form the perforation line.

### RELATED APPLICATIONS

This application claims priority under 35 U.S.C. §119 to Japanese Patent Application No. 2011-181937 filed on Aug. 23, 2011, the entire content of which is hereby incorporated by reference.

### BACKGROUND OF THE INVENTION

1. Field of the Invention

The present invention relates to a pressure-sensitive adhesive strength exhibiting unit for causing a pressure-sensitive adhesive label to exhibit pressure-sensitive adhesive strength, and a pressure-sensitive adhesive label issuing device and a printer including the pressure-sensitive adhesive strength exhibiting unit.

2. Description of the Related Art

Conventionally, as pressure-sensitive adhesive labels used for, for example, a POS label for foods, a logistics/transportation label, a medical label, a baggage tag, and an indication label for bottles and cans, those which are formed of a recording surface (printing surface) formed on a front surface of a base, a pressure-sensitive adhesive layer formed on a rear surface of the base, and release paper (separator) covering the pressure-sensitive adhesive layer have been widely known.

Therefore, when the pressure-sensitive adhesive label is used, it is necessary to release the release paper from the pressure-sensitive adhesive layer after printing predetermined information such as a bar code and a price on the recording surface. However, it is actually difficult to recover and recycle the released release paper, and hence, there is a problem that the release paper becomes an industrial waste.

In recent years, a pressure-sensitive adhesive label that does not use release paper has come to be used from the viewpoint of environment protection and alleviation of an environmental burden.

For example, a pressure-sensitive adhesive label is known, in which the surface of a recording surface is coated with a release agent such as silicon resin, and a release property between the recording surface and a pressure-sensitive adhesive layer is kept even when the pressure-sensitive adhesive label is rolled into a roll shape. Further, a pressure-sensitive adhesive label is known, which uses, as a pressure-sensitive adhesive layer, a thermally active pressure-sensitive adhesive layer that exhibits pressure-sensitive adhesiveness by heating. Further, a pressure-sensitive adhesive label has been proposed, in which the entire surface of a pressure-sensitive adhesive layer is covered with a non-pressure-sensitive-adhesive resin layer, and the pressure-sensitive adhesive layer is exposed by forming bores (minute openings) in the resin layer by heating to exhibit pressure-sensitive adhesiveness.

Of those pressure-sensitive adhesive labels, the pressure-sensitive adhesive label in which the pressure-sensitive adhesive layer is covered with the resin layer has an advantage that pressure-sensitive adhesive strength can be controlled freely by controlling portions for forming bores in the resin layer freely to cause only required regions to exhibit pressure-sensitive adhesiveness or contrarily by reducing the portions for forming bores to decrease pressure-sensitive adhesive strength.

In this case, as means for forming bores by heating the resin layer, a thermal head in which a plurality of heat-generating elements are aligned in a line shape is effective. This is because only the desired heat-generating elements are selectively allowed to generate heat, and hence, positions for forming the bores can be controlled freely.

However, for example, in the case where the above-mentioned bores are formed continuously in a plurality of lines in a resin layer through use of a thermal head so as to expose a pressure-sensitive adhesive layer densely, thereby enhancing pressure-sensitive adhesive strength, it is difficult to form all the bores in a shape corresponding to heat-generating elements in some cases.

The reason for the above is described in detail.

The case is exemplified in which a plurality of heat-generating elements 111 of a thermal head 110 are applied with heat energy to generate heat while a pressure-sensitive adhesive label 100 is fed in an arrow direction as illustrated in FIG. 13, and a plurality of (three in the illustrated case) perforation lines L in which a plurality of bores 120 are aligned in a label width direction are formed continuously in a resin layer 101 of the pressure-sensitive adhesive label 100 as illustrated in FIG. 14.

FIG. 14 illustrates an ideal state in which the bores 120 of all the perforation lines L (L1 to L3) are formed so as to correspond to the shape of the heat-generating elements 111, and the pressure-sensitive adhesive layer 102 of the pressure-sensitive adhesive label 100 is exposed uniformly.

First, as illustrated in FIGS. 13 and 14, when the heat-generating elements 111 of the thermal head 110 are caused to generate heat to form a first perforation line L (L1) in the resin layer 101 of the pressure-sensitive adhesive label 100, a part of the resin layer 101 molten by heating runs diffusely to the periphery of the bores 120, whereas the remaining molten part adheres to the heat-generating elements 111 easily.

Therefore, as illustrated in FIGS. 15 and 16, a part 101a of the resin layer 101 adhering to the heat-generating element 111 easily turns up along with the label feeding (arrow direction in the figure) of the pressure-sensitive adhesive label 100 and easily flows so as to overlap the resin layer 101 positioned on a downstream side of the perforation line L (L1) due to the further label feeding.

Accordingly, a film thickness (T1) of the resin layer 101 in a portion in which a second perforation line L (L2) is to be formed easily becomes larger than a film thickness (T2) in the other portions. Therefore, even when the heat-generating elements 111 are caused to generate heat with the same heat quantity as that for the first perforation line L (L1), it is difficult to form the second perforation line L (L2) in a desired bore shape or there is a high risk that the second perforation line L (L2) may be formed with an opening area smaller than that of the first perforation line L (L1).

Consequently, it is difficult to form the bores 120 of all the perforation lines L in a bore shape corresponding to the heat-generating elements 111, and actually, it is difficult to obtain an ideal opening state as illustrated in FIG. 14. Thus, there is a risk that the perforation lines L cannot be formed in a stable bore shape, and hence desired pressure-sensitive adhesive strength may not be exhibited.

### SUMMARY OF THE INVENTION

According to an exemplary embodiment of the invention, there is provided a pressure-sensitive adhesive strength exhibiting unit for heating a pressure-sensitive adhesive label to cause the pressure-sensitive adhesive label to exhibit pressure-sensitive adhesive strength, the pressure-sensitive adhesive label including a printable layer provided on one surface of a base and a pressure-sensitive adhesive layer covered with a non-pressure sensitive-adhesive functional layer and provided on another surface of the base, the pressure-sensitive adhesive strength exhibiting unit including: a thermal head including a plurality of heat-generating elements aligned in a row, for heating the pressure-sensitive adhesive label from the pressure-sensitive adhesive layer side to cause each of the plurality of heat-generating elements to form a bore in the non-pressure-sensitive-adhesive functional layer; a platen roller for conveying the pressure-sensitive adhesive label while sandwiching the pressure-sensitive adhesive label between the thermal head and the platen roller; and a control part for applying heat energy to each of the plurality of heat-generating elements independently to control heat generation, in which, when the control part continuously forms a plurality of perforation lines in which a plurality of the bores are aligned in a row by repeating the application of heat energy, the control part applies high heat energy, whose energy amount is higher than an energy amount of heat energy applied to the heat-generating elements during formation of a previous perforation line, to the heat-generating elements to form the perforation line.

In the pressure-sensitive adhesive strength exhibiting unit, when the control part applies heat energy to each of the plurality of heat-generating elements of the thermal head independently, each heat-generating element applied with the heat energy generates heat in an energy amount (heat quantity) of the heat energy. Therefore, only a portion with which each heat-generating element is in contact of the functional layer of the pressure-sensitive adhesive label that is in contact with the thermal head can be heated locally, and the portion is molten to form a bore. Thus, a perforation line in which bores are aligned in a row can be formed in the functional layer.

Further, when the bores are formed, the pressure-sensitive adhesive layer of the pressure-sensitive adhesive label is exposed through the bores, and hence, pressure-sensitive adhesive strength can be exhibited. Then, the perforation line can be formed in the functional layer in a plurality of lines continuously in the conveyance direction by repeating the application of heat energy to the plurality of heat-generating elements along with the conveyance of the pressure-sensitive adhesive label by the platen roller. Thus, pressure-sensitive adhesive strength can be exhibited in a desired region of the pressure-sensitive adhesive label.

When the control part forms a plurality of perforation lines, the control part controls so that the current perforation line is formed by applying high heat energy, whose energy amount is higher than that of the heat energy applied to the heat-generating elements for forming a previous perforation line, to the heat-generating elements. For example, a second perforation line is formed by applying high heat energy whose energy amount is higher than that of the heat energy applied during formation of the first perforation line.

Therefore, even if a part of the molten functional layer adheres to the thermal head and overlaps the functional layer at a position where the second perforation line is to be formed to increase the film thickness along with the conveyance of the pressure-sensitive adhesive label at a time of forming a first perforation line, the functional layer whose film thickness has increased can be heated with a sufficient energy amount. Thus, in the same way as in the case of forming a first perforation line, the functional layer can be molten without fail, and a perforation line having bores opened appropriately can be formed continuously.

As a result, all the bores in a plurality of perforation lines can be formed in a uniform bore shape corresponding to the heat-generating elements, and the pressure-sensitive adhesive label is allowed to exhibit stable pressure-sensitive adhesive strength.

In the above-mentioned pressure-sensitive adhesive strength exhibiting unit, it is preferred that, for forming the plurality of the perforation lines, in a case where it is necessary to apply the heat energy continuously to the same heat-generating elements, the control part apply the high heat energy only to the heat-generating elements concerned.

In this case, only when the same heat-generating elements are required to be applied with heat energy continuously, the heat-generating elements are applied with high heat energy, instead of applying high heat energy to all the heat-generating elements uniformly. More specifically, every time each perforation line is formed, heat-generating elements may be classified into those which are required to be applied with heat energy and those which are not required to be applied with heat energy, depending upon the position, size, and level of pressure-sensitive adhesive strength of a region in which pressure-sensitive adhesive strength is desired to exhibit. In this case, for example, the heat-generating elements applied with heat energy during formation of a first perforation line may or may not be continuously applied with heat energy during formation of a second perforation line.

When the same heat-generating elements are continuously applied with heat energy, the control part applies high heat energy to the heat-generating elements. Thus, only the heat-generating elements required to be applied with heat energy are applied with high heat energy, and hence, power consumption and rise in temperature of the thermal head can be suppressed easily.

In the above-mentioned pressure-sensitive adhesive strength exhibiting unit, it is preferred that, in a case where the heat energy is applied to the same heat-generating elements continuously in at least three lines, the control part continuously apply the high heat energy, which has been applied to a second line, in third and subsequent lines.

In this case, for forming at least three perforation lines continuously by applying heat energy continuously to the same heat-generating elements, the control part continuously applies high heat energy in the second line with an enhanced energy amount to the third and subsequent lines instead of enhancing the energy amount gradually. Thus, the power consumption and rise in temperature of the thermal head can be effectively suppressed easily.

In the above-mentioned pressure-sensitive adhesive strength exhibiting unit, it is preferred that, for forming the plurality of the perforation lines, in a case where the application of heat energy to the heat-generating elements to which the high heat energy has been applied is stopped once, and thereafter the application of heat energy to the heat-generating elements is restarted during formation of a subsequent perforation line, the control part apply the initially applied heat energy to the heat-generating elements.

In this case, the application of heat energy to the heat-generating elements is once stopped. Therefore, even when a part of the molten functional layer adheres to the thermal head, the part can be easily removed while the application of heat energy is stopped and does not easily affect the functional layer at a position where a subsequent perforation line is to be formed. Thus, bores can be formed in the same state as that during formation of a first perforation line, and the bores can be formed in a uniform bore shape corresponding to the heat-generating elements through use of the initially applied heat energy.

In particular, the energy amount of heat energy can be returned to the original, and hence, unnecessary power consumption can be suppressed easily and the rise in temperature of the thermal head can be suppressed easily.

In the above-mentioned pressure-sensitive adhesive strength exhibiting unit, it is preferred that the high heat energy be higher than and twice or less the energy amount of the initially applied heat energy.

In this case, the energy amount is set to be about twice at most for applying high heat energy, and hence, bores can be formed stably in a bore shape corresponding to the heat-generating elements while power consumption is minimized.

In the above-mentioned pressure-sensitive adhesive strength exhibiting unit, it is preferred that the control part enhance an energy amount by increasing a pulse width of an applied voltage compared with a pulse width during the application of the heat energy, and apply the heat energy with the enhanced energy amount as the high heat energy.

In this case, the energy amount can be enhanced with simple control of increasing a pulse width of an applied voltage (increasing an application time) while keeping applied power constant (keeping a resistance and an applied voltage constant), and hence, heat energy in a desired energy amount is precisely applied to the heat-generating elements easily.

In the above-mentioned pressure-sensitive adhesive strength exhibiting unit, it is preferred that the control part perform the application of heat energy periodically so that a plurality of the perforation lines are aligned continuously at a narrow pitch equal to or less than a pitch between the heat-generating elements.

In this case, bores formed in a bore shape corresponding to the heat-generating elements can be formed in a plurality of lines at the above-mentioned narrow pitch, and hence, for example, a desired region of the pressure-sensitive adhesive label is allowed to exhibit pressure-sensitive adhesive strength intensively. Thus, high pressure-sensitive adhesive strength is ensured easily.

It is preferred that the above-mentioned pressure-sensitive adhesive strength exhibiting unit further include a temperature detection sensor for detecting a temperature of the thermal head, and the control part calculate a change in temperature characteristics of the thermal head based on the temperature detected by the temperature detection sensor and perform the application of heat energy while correcting an energy amount in accordance with the changed temperature characteristics.

In this case, heat energy is applied while an energy amount is corrected in accordance with the temperature characteristics of the thermal head due to the heat storage effect, and hence, heat energy in a more appropriate energy amount can be applied, and bores in a bore shape corresponding to the heat-generating elements can be formed more stably.

In the above-mentioned pressure-sensitive adhesive strength exhibiting unit, it is preferred that the control part calculate a change in temperature characteristics of the thermal head based on a number of the heat-generating elements to which the application of heat energy is performed simultaneously and perform the application of heat energy while correcting an energy amount in accordance with the changed temperature characteristics.

In this case, the temperature characteristics of the thermal head change due to the heat storage effect depending on the number of the heat-generating elements to which heat energy is applied simultaneously. However, heat energy is applied while an energy amount is corrected in accordance with the temperature characteristics, and hence, heat energy in a more appropriate energy amount can be applied, and bores in a bore shape corresponding to the heat-generating elements can be formed more stably.

A pressure-sensitive adhesive label issuing device according to an exemplary embodiment includes: the above-mentioned pressure-sensitive adhesive strength exhibiting unit; and a cutter unit placed on an upstream side of the pressure-sensitive adhesive strength exhibiting unit in a conveyance direction, for cutting band-shaped label paper to a predetermined length and transferring the cut label paper to the pressure-sensitive adhesive strength exhibiting unit as the pressure-sensitive adhesive label.

In the pressure-sensitive adhesive label issuing device, band-shaped label paper is cut to a desired length with the cutter unit, and thereafter, the functional layer in only a desired region is heated with the pressure-sensitive adhesive strength exhibiting unit to exhibit stable pressure-sensitive adhesive strength, and hence, a pressure-sensitive adhesive label of high quality can be issued.

A printer according to an exemplary embodiment includes: the above-mentioned pressure-sensitive adhesive label issuing device; and a printing unit placed on an upstream side of the pressure-sensitive adhesive strength exhibiting unit in the conveyance direction, for printing on the printable layer.

In the printer, desired information can be printed on the printable layer stably before pressure-sensitive adhesive strength is exhibited by the pressure-sensitive adhesive strength exhibiting unit, and hence, a pressure-sensitive adhesive label of high quality can be obtained in which various kinds of pieces of information are printed clearly and stable pressure-sensitive adhesive strength is exhibited.

As a result, all bores can be formed in a uniform bore shape corresponding to the heat-generating elements even when forming a plurality of the perforation lines continuously, and stable pressure-sensitive adhesive strength can be exhibited on the pressure-sensitive adhesive label.

### BRIEF DESCRIPTION OF THE DRAWINGS

In the accompanying drawings:

FIG. 1 is a structural diagram of a pressure-sensitive adhesive label issuing device including a pressure-sensitive adhesive strength exhibiting unit, illustrating a first embodiment according to the present invention;

FIG. 2 is an enlarged cross-sectional view of a pressure-sensitive adhesive label illustrated in FIG. 1;

FIG. 3 is a plan view of a thermal head of the pressure-sensitive adhesive strength exhibiting unit illustrated in FIG. 1;

FIG. 4 is a cross-sectional view taken along line A-A of the thermal head illustrated in FIG. 3;

FIG. 5 is an enlarged plan view of electrode parts and heat-generating elements of the thermal head illustrated in FIG. 3;

FIG. 6 is a structural diagram of the pressure-sensitive adhesive strength exhibiting unit illustrated in FIG. 1;

FIG. 7 is a plan view of a pressure-sensitive adhesive label, illustrating a state in which a plurality of perforation lines are formed in a functional layer to exhibit pressure-sensitive adhesive strength;

FIG. 8 is a structural diagram of a pressure-sensitive adhesive label issuing device including a pressure-sensitive adhesive strength exhibiting unit, illustrating a second embodiment according to the present invention;

FIG. 9 is a structural diagram of the pressure-sensitive adhesive strength exhibiting unit illustrated in FIG. 8;

FIG. 10 is a flowchart showing steps of issuing a pressure-sensitive adhesive label;

FIG. 11 illustrates a relationship between perforation lines and heat-generating elements for issuing a pressure-sensitive adhesive label;

FIG. 12 is a structural diagram of a printer including a pressure-sensitive adhesive label issuing device, illustrating a third embodiment according to the present invention;

FIG. 13 is an enlarged cross-sectional view of a thermal head and a pressure-sensitive adhesive label in the case of causing a pressure-sensitive adhesive label to exhibit pressure-sensitive adhesive strength by a conventional method;

FIG. 14 illustrates a state in which a plurality of perforation lines are formed in a functional layer to exhibit pressure-sensitive adhesive strength, and bores are opened in an ideal bore shape;

FIG. 15 is a cross-sectional view illustrating a state in which a pressure-sensitive adhesive label is fed after the state illustrated in FIG. 13; and

FIG. 16 is a cross-sectional view illustrating a state in which the pressure-sensitive adhesive label is further fed after the state illustrated in FIG. 15.

### DETAILED DESCRIPTION OF THE PREFERRED EMBODIMENTS

Hereinafter, a first embodiment according to the present invention is described with reference to the drawings.

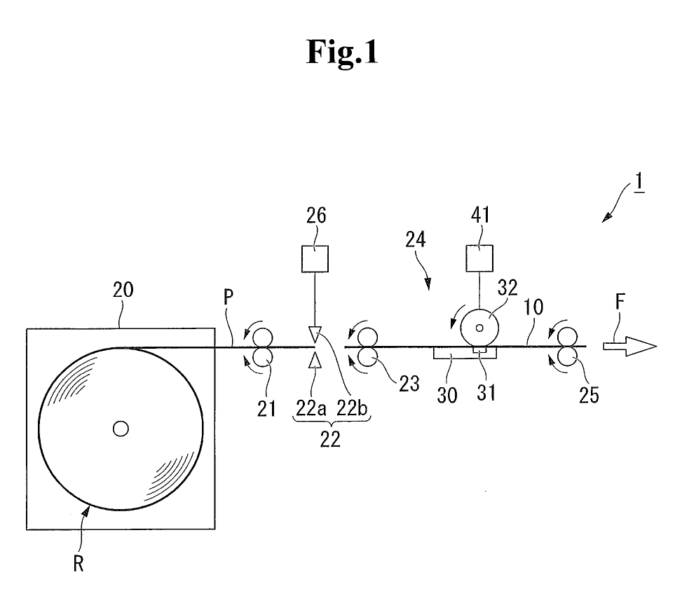

As illustrated in FIG. 1, a pressure-sensitive adhesive label issuing device 1 of this embodiment uses roll paper R for a pressure-sensitive adhesive label 10, cuts band-shaped label paper P unrolled from the roll paper R to a predetermined length to obtain the pressure-sensitive adhesive label 10, and issues the pressure-sensitive adhesive label 10 with pressure-sensitive adhesive strength exhibited.

In this embodiment, in the state illustrated in FIG. 1, it is assumed that the right side on the sheet is defined as a front side F and the left side is defined as a back side, and the label paper P and the pressure-sensitive adhesive label 10 are fed to the front side F. Further, the upper side of the sheet is defined as an upside and the lower side thereof is defined as a downside.

The roll paper R has a configuration in which the band-shaped label paper P is rolled around a core member (not shown). As described above, the band-shaped label paper P is cut to form the pressure-sensitive adhesive label 10.

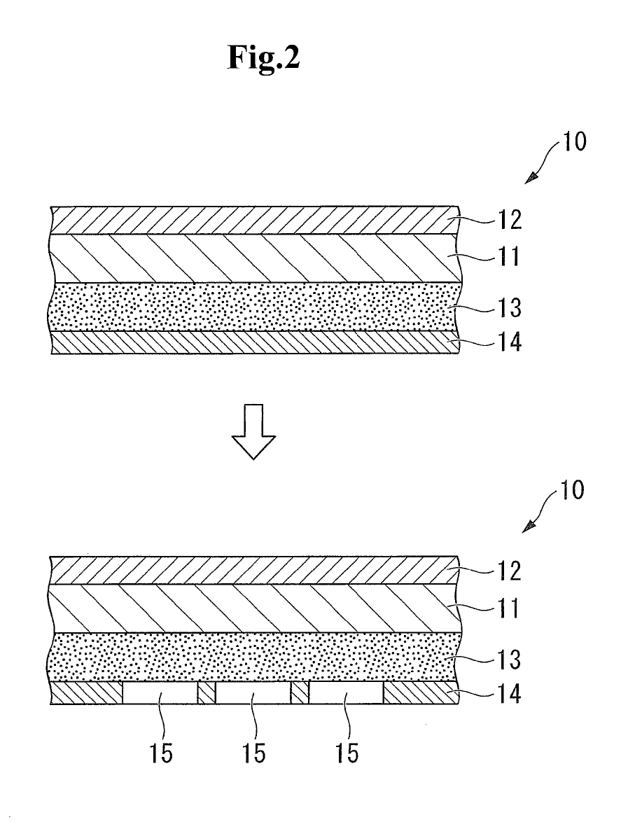

As illustrated in FIG. 2, the pressure-sensitive adhesive label 10 includes a base 11, a printable layer 12 laminated on one surface of the base 11, a pressure-sensitive adhesive layer 13 laminated on the other surface of the base 11, and a non-pressure-sensitive-adhesive functional layer 14 for covering the pressure-sensitive adhesive layer 13 to regulate the adhesion thereof.

The printable layer 12 is a thermosensitive recording layer that develops color by heating and formed over one entire surface of the base 11. The pressure-sensitive adhesive layer 13 is formed of, for example, a pressure-sensitive adhesive that exhibits pressure-sensitive adhesiveness merely by being applied with a slight pressure at room temperature for a short period of time without using water, a solvent, or heat, and formed over the other entire surface of the base 11.

It is preferred that the pressure-sensitive adhesive have both cohesion and an elastic force, and high pressure-sensitive adhesiveness, and be easily released. Note that, the pressure-sensitive adhesive layer 13 is not limited to the one that is formed of a pressure-sensitive adhesive and may be, for example, the one that is formed of a rubber-based pressure-sensitive adhesive such as natural rubber, styrene butadiene rubber (SBR), or polyisobutylene rubber; a non-crosslinking acrylic pressure-sensitive adhesive obtained by copolymerizing a monomer having a low glass transition point with a monomer having a high glass transition point; or a silicon-based pressure-sensitive adhesive made of silicon having high cohesion and silicon resin having high pressure-sensitive adhesive strength.

The functional layer 14 covers the entire surface of the pressure-sensitive adhesive layer 13 and is formed of a thermosensitive film or the like in which bores 15 are formed by heating. The bores 15 refer to bores formed when the functional layer 14 is heated locally by heat-generating elements 31 of a thermal head 30 described later. When the bores 15 are formed, a resin layer is exposed outside through the bores 15, and hence pressure-sensitive adhesive strength is exhibited.

The pressure-sensitive adhesive label issuing device 1 is described.

As illustrated in FIG. 1, the pressure-sensitive adhesive label issuing device 1 includes a holding part 20 for pivoting the roll paper R, first conveying rollers 21 for conveying the label paper P unrolled from the roll paper R to the front side F, a cutter unit 22 for cutting the label paper P conveyed by the first conveying rollers 21 to a desired length to form the pressure-sensitive adhesive label 10, second conveying rollers 23 for conveying the cut pressure-sensitive adhesive label 10 to the front side F, a pressure-sensitive adhesive strength exhibiting unit 24 for heating the pressure-sensitive adhesive label 10 conveyed by the second conveying rollers 23 from the functional layer 14 side to cause pressure-sensitive adhesive strength to be exhibited, and third conveying rollers 25 for further conveying the pressure-sensitive adhesive label 10 with pressure-sensitive adhesive strength exhibited to the front side F.

The cutter unit 22 is a cutter mechanism having a fixed blade 22a and a movable blade 22b placed so that blade edges are opposed to each other across the label paper P in a vertical direction, and is placed on a downstream side of the first conveying rollers 21 in a conveyance direction and on an upstream side of the second conveying rollers 23 in the conveyance direction. The fixed blade 22a is placed on the downside of the label paper P, and the movable blade 22b is placed on the upside of the label paper P. The fixed blade 22a may be placed on the upside of the label paper P, and the movable blade 22b may be placed on the downside thereof.

The movable blade 22b can slide to approach or be separate with respect to the fixed blade 22a due to the drive by a cutter drive part 26 and can cut the label paper P while sandwiching the label paper P between the movable blade 22b and the fixed blade 22a in the vertical direction. The pressure-sensitive adhesive label 10 obtained due to cutting by the cutter unit 22 is transferred to the pressure-sensitive adhesive strength exhibiting unit 24 via the second conveying rollers 23.

The pressure-sensitive adhesive strength exhibiting unit 24 includes a plurality of heat-generating elements 31 aligned in a row, and has the thermal head (line thermal head) 30 for forming the bores 15 in the functional layer 14 by heating the functional layer 14 of the pressure-sensitive adhesive label 10 with each of the heat-generating elements 31 independently, and a platen roller 32 for conveying the pressure-sensitive adhesive label 10 to the front side F while sandwiching the pressure-sensitive adhesive label 10 between the thermal head 30 and the platen roller 32.

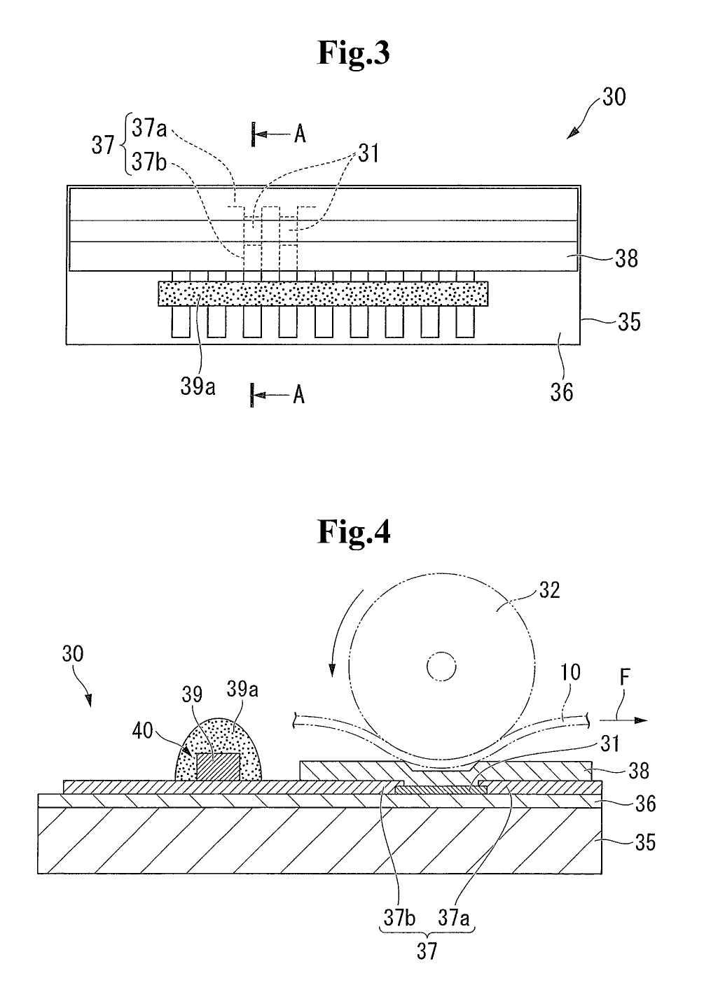

As illustrated in FIGS. 3 and 4, the thermal head 30 includes a ceramic substrate 35 that is a heat-radiating substrate, a glaze layer (heat storage layer) 36 laminated over the entire surface of the ceramic substrate 35, heat-generating elements 31 and an electrode part 37 laminated on the glaze layer 36, and a protective layer 38 for protecting the heat-generating elements 31 and a part of the electrode part 37.

The ceramic substrate 35 is supported by a head support substrate (not shown) and urged to the platen roller 32 side by a coil spring or the like (not shown) to come into pressure contact with an outer circumferential surface of the platen roller 32. Thus, the pressure-sensitive adhesive label 10 is sandwiched between the thermal head 30 and the platen roller 32 and is pressed against the thermal head 30 (see FIG. 4).

The glaze layer 36 is formed, for example, when a printed glass paste is baked at a predetermined temperature (e.g., 1,300° C. to 1,500° C.).

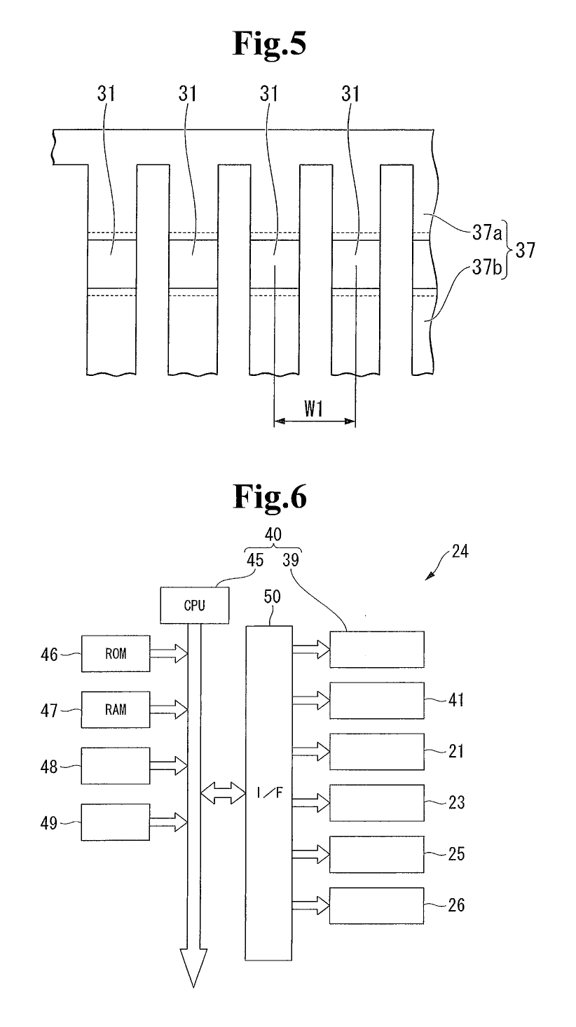

The heat-generating elements 31 are formed by laminating a heat-generating resistive member made of, for example, Ta—SiO₂ on the glaze layer 36 by sputtering or the like, and patterning the heat-generating resistive member by photolithography or the like. At this time, as illustrated in FIG. 5, the heat-generating elements 31 are aligned at an equal interval with a predetermined pitch W1 in a row in a longitudinal direction of the ceramic substrate 35. Each heat-generating element 31 has a substantially square shape in a planar view.

As illustrated in FIGS. 3 to 5, the electrode part 37 is formed by laminating, for example, a layer of Al, Cu, or Au on the glaze layer 36 by sputtering or the like and patterning the layer of Al, Cu, or Au by photolithography or the like. The electrode part 37 includes a common electrode part 37a that is electrically connected to all the plurality of heat-generating elements 31 and individual electrode parts 37b that are electrically connected to the respective heat-generating elements 31. Thus, heat energy can be applied to each of the plurality of heat-generating elements 31 through the electrode part 37 to cause each heat-generating element 31 to generate heat independently.

Further, an IC part 39 protected by a sealing part 39a made of resin is mounted on each individual electrode part 37b. The IC parts 39 cooperate with a CPU 45 described later to control the heat generation of the heat-generating elements 31.

Thus, the IC parts 39 and the CPU 45 function as a control part 40 for controlling the heat generation by applying heat energy to each of the plurality of heat-generating elements 31 independently through the electrode part 37.

The protective layer 38 prevents oxidation and abrasion of the electrode part 37 and the heat-generating elements 31, and is formed of, for example, a hard metal oxide such as Si—O—N or Si—Al—O—N. Then, the protective layer 38 completely covers and protects the plurality of heat-generating elements 31 and the common electrode part 37a and covers and protects a part of the individual electrode parts 37b.

As illustrated in FIGS. 1 and 4, the platen roller 32 is a rubber roller rotated to the front side F by a drive motor 41 whose drive is controlled by the CPU 45 described later, and conveys the pressure-sensitive adhesive label 10 to the front side F while sandwiching the pressure-sensitive adhesive label 10 between the thermal head 30 and the platen roller 32.

As illustrated in FIG. 6, the pressure-sensitive adhesive strength exhibiting unit 24 of this embodiment includes the CPU 45, a ROM 46 storing a control program and the like to be executed by the CPU 45, a RAM 47 storing formation pattern data and the like of the bores 15 to be formed in the functional layer 14, an operation part 48 for inputting, setting, or invoking the formation pattern data and the like of the bores 15, a display part 49 for displaying the formation pattern data and the like of the bores 15, and an interface part (I/F part) 50 for inputting/outputting data between the CPU 45 and each of the above-mentioned function parts.

The IC parts 39 of the thermal head 30, the drive motor 41 of the platen roller 32, the first to third conveying rollers 21, 23, and 25, and the cutter drive part 26 are respectively connected to the interface part 50, and the respective operations are controlled.

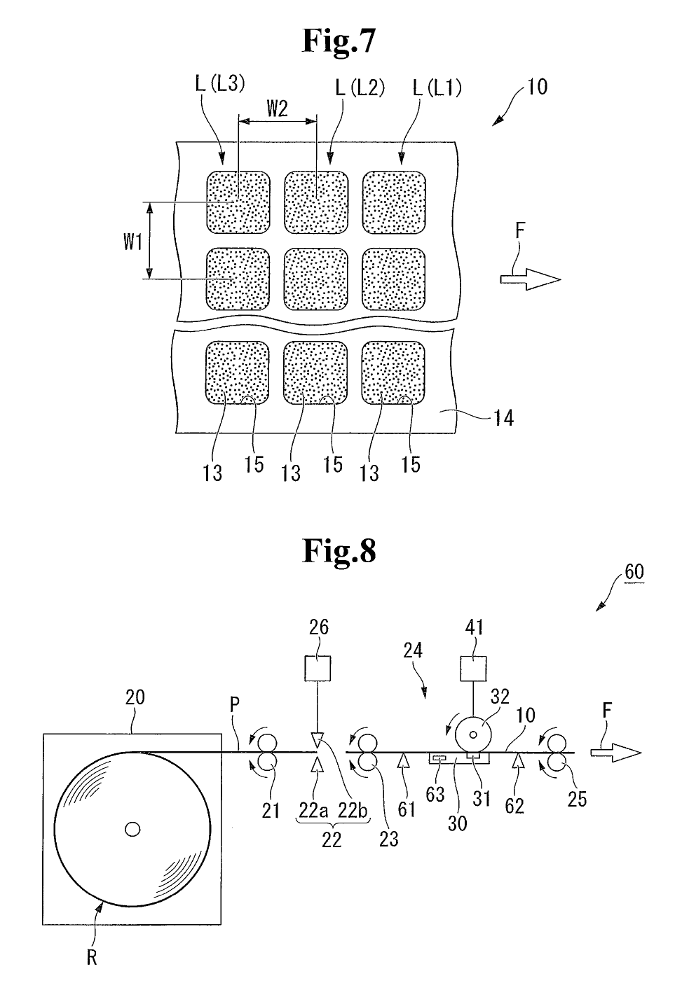

The control part 40 constituted by the CPU 45 and the IC parts 39 applies heat energy to the plurality of heat-generating elements 31 along with the drive of the platen roller 32 repeatedly, thereby controlling the heat-generating elements 31 to continuously form a plurality of perforation lines L in which the plurality of bores 15 are aligned in a row in the functional layer 14 of the pressure-sensitive adhesive label 10 as illustrated in FIGS. 2 and 7. In the illustrated example, three perforation lines L are formed continuously in the conveyance direction.

In particular, the control part 40 applies to the heat-generating elements 31 heat energy having an energy amount higher than that of heat energy applied to the heat-generating elements 31 when forming the previous perforation line L, thereby controlling the heat-generating elements 31 to form the perforation lines L.

The energy amount is determined based on a pulse width of an applied voltage and applied power, and the applied power is determined based on an average resistance of the heat-generating elements 31 and the applied voltage to the heat-generating elements 31.

In this embodiment, the control part 40 enhances an energy amount by increasing the pulse width (increasing an application time) to apply high heat energy.

### Production of a Pressure-Sensitive Adhesive Label

Next, the case is described in which the pressure-sensitive adhesive label 10 is issued with pressure-sensitive adhesive strength exhibited through use of the pressure-sensitive adhesive label issuing device 1 including the pressure-sensitive adhesive strength exhibiting unit 24 configured as described above. In this embodiment, it is assumed that information has already been printed on the printable layer 12 in the stage in which the pressure-sensitive adhesive label is rolled into the roll paper R.

First, the CPU 45 drives the first to third conveying rollers 21, 23, and 25 and operates the drive motor 41 to rotate the platen roller 32, and further operates each IC part 39 to apply heat energy to each of the plurality of heat-generating elements 31 of the thermal head 30.

As illustrated in FIG. 1, when the first conveying rollers 21 are driven, the label paper P is unrolled from the roll paper R held pivotally in the holding part 20 and conveyed to the front side F while passing between the fixed blade 22a and the movable blade 22b of the cutter unit 22. Then, when the label paper P passes by a desired length, the CPU 45 operates the cutter drive part 26 to slide the movable blade 22b toward the fixed blade 22a. This enables the label paper P to be cut while sandwiching the label paper P between the movable blade 22b and the fixed blade 22a, thereby adjusting the pressure-sensitive adhesive label 10 to a desired length.

The cut pressure-sensitive adhesive label 10 is conveyed further to the front side F by the second conveying rollers 23 to be fed between the thermal head 30 and the platen roller 32 of the pressure-sensitive adhesive strength exhibiting unit 24 and conveyed to the front side F while being pressed against the thermal head 30 by the platen roller 32.

At this time, the control part 40 applies heat energy to each of a plurality of heat-generating elements 31 of the thermal head 30 independently, and hence, each heat-generating element 31 applied with the heat energy generates heat in an energy amount (heat quantity) of the heat energy. Therefore, only a portion with which each heat-generating element 31 is in contact of the functional layer 14 of the pressure-sensitive adhesive label 10 that is in pressure contact with the thermal head 30 by the platen roller 32 can be heated locally through the protective layer 38, and the portion is molten to form a bore 15. Thus, as illustrated in FIG. 7, the first perforation line L (L1) in which bores 15 are aligned in a row can be formed in the functional layer 14.

Further, when the bores 15 are formed, the pressure-sensitive adhesive layer 13 of the pressure-sensitive adhesive label 10 is exposed through the bores 15, and hence pressure-sensitive adhesive strength can be exhibited. Then, three perforation lines L (L1 to L3) can be formed in the functional layer 14 continuously in the conveyance direction by repeating the application of heat energy to the plurality of heat-generating elements 31 along with the conveyance of the pressure-sensitive adhesive label 10 by the platen roller 32. Thus, pressure-sensitive adhesive strength can be exhibited in a desired region of the pressure-sensitive adhesive label 10.

When the control part 40 forms a plurality of perforation lines L, the control part 40 controls so that the current perforation line is formed by applying high heat energy, whose energy amount is higher than that of the heat energy applied to the heat-generating elements 31 for forming a previous perforation line L, to the heat-generating elements 31.

That is, a second perforation line L (L2) is formed by applying high heat energy whose energy amount is higher than that of the heat energy applied during formation of the first perforation line L (L1). More specifically, the energy amount is enhanced by increasing the pulse width of an applied voltage (increasing an application time) while keeping applied power constant (keeping a resistance and an applied voltage of the heat-generating elements 31 constant), and high heat energy is applied.

Therefore, even if a part of the molten functional layer 14 adheres to the thermal head 30 and overlaps the functional layer 14 at a position where the second perforation line L (L2) is to be formed to increase the film thickness along with the conveyance of the pressure-sensitive adhesive label 10 at a time of forming a first perforation line L (L1), the functional layer 14 whose film thickness has increased can be heated with a sufficient energy amount. Thus, in the same way as in the case of forming a first perforation line L (L1), the functional layer 14 can be molten without fail, and a perforation line L having bores 15 opened appropriately can be formed continuously.

Consequently, as illustrated in FIG. 7, all the bores 15 in the three perforation lines L (L1 to L3) can be formed in a uniform bore shape corresponding to the heat-generating elements 31, and the pressure-sensitive adhesive label 10 is allowed to exhibit stable pressure-sensitive adhesive strength.

The pressure-sensitive adhesive label 10 with pressure-sensitive adhesive strength exhibited is conveyed to the front side F by the third conveying rollers 25. Thus, the pressure-sensitive adhesive label 10 can be issued with pressure-sensitive adhesive strength exhibited.

As described above, the pressure-sensitive adhesive label issuing device 1 of this embodiment enables only a desired region to exhibit stable pressure-sensitive adhesive strength through use of the pressure-sensitive adhesive strength exhibiting unit 24 after cutting the label paper P to a desired length with the cutter unit 22, to thereby issue the pressure-sensitive adhesive label 10 of high quality.

In this embodiment, although the first to third conveying rollers 21, 23, and 25 are provided, the first to third conveying rollers 21, 23, and 25 may not be provided or three or more kinds of conveying rollers may be provided in accordance with a conveyance path or the like. Further, the setting positions thereof may be set appropriately.

Further, although the energy amount is enhanced by increasing the pulse width of an applied voltage, the present invention is not limited thereto, and the energy amount may be enhanced, for example, by increasing an applied voltage. Note that, the energy amount can be enhanced with simpler control in the case of increasing the pulse width, rather than the case of changing an applied voltage, and hence, a desired amount of heat energy is easily applied to the heat-generating elements 31 precisely.

Further, in this embodiment, in the case where high heat energy is applied, an energy amount may be larger than and twice or less that of heat energy applied initially. Specifically, if high heat energy of an energy amount, which is larger by about 1.3 to 1.7 times that of heat energy applied initially, is applied, the bores 15 in a bore shape corresponding to the heat-generating elements 31 can be formed, although the energy amount varies depending upon the material, film thickness and the like of the functional layer 14 of the pressure-sensitive adhesive label 10.

Particularly, in this case, the energy amount only needs to be increased about twice at most, and hence, the bores 15 in a bore shape corresponding to the heat-generating elements 31 can be formed stably while power consumption is suppressed as much as possible.

Further, in this embodiment, as illustrated in FIG. 7, heat energy may be applied periodically so that a plurality of perforation lines L are aligned continuously at a narrow pitch W2 equal to or less than a pitch W1 between the heat-generating elements 31. Thus, the bores 15 formed in a bore shape corresponding to the heat-generating elements 31 can be formed in a plurality of lines at the narrow pitch W2, and hence, for example, pressure-sensitive adhesive strength is allowed to be exhibited intensively in a desired region of the pressure-sensitive adhesive label 10 to ensure strong pressure-sensitive adhesive strength easily.

Next, a second embodiment according to the present invention is described. In the second embodiment, the same constituent elements as those in the first embodiment are denoted with the same reference symbols as those therein and the descriptions thereof are omitted.

As illustrated in FIG. 8, a pressure-sensitive adhesive label issuing device 60 of this embodiment includes a first detection sensor 61 and a second detection sensor 62 for detecting the presence/absence of the conveyed pressure-sensitive adhesive label 10, and a temperature detection sensor 63 for detecting the temperature of the thermal head 30.

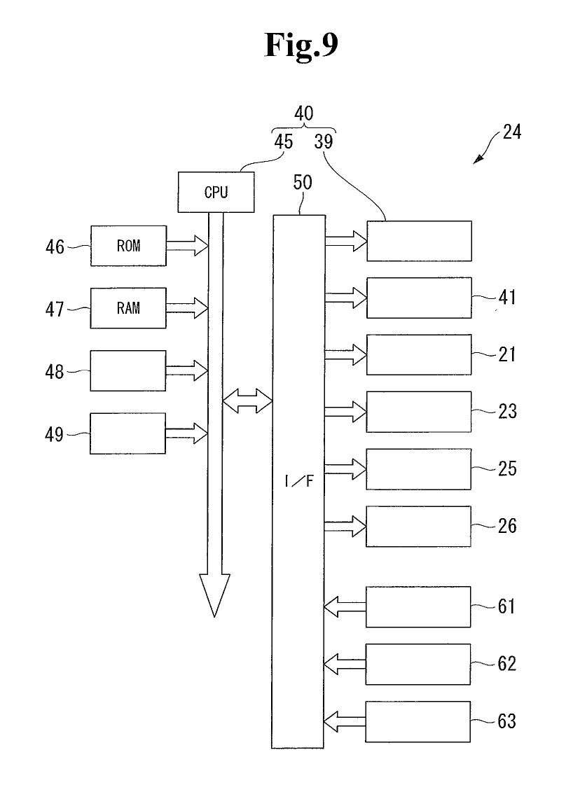

The first detection sensor 61 is placed between the pressure-sensitive adhesive strength exhibiting unit 24 and the second conveying rollers 23 and detects whether or not the pressure-sensitive adhesive label 10 has been conveyed to the pressure-sensitive adhesive strength exhibiting unit 24. Further, the second detection sensor 62 is placed between the pressure-sensitive adhesive strength exhibiting unit 24 and the third conveying rollers 25 and detects whether or not the pressure-sensitive adhesive label 10 has been fed out of the pressure-sensitive adhesive strength exhibiting unit 24. The first detection sensor 61 and the second detection sensor 62 are, for example, photoelectric non-contact sensors, and as illustrated in FIG. 9, detection results are output to the CPU 45 through the interface part 50.

The temperature detection sensor 63 is, for example, a thermistor contained in the ceramic substrate 35 and similarly outputs a detection result to the CPU 45 through the interface part 50.

Further, for forming the respective perforation lines L, the CPU 45 of this embodiment classifies the plurality of heat-generating elements 31 into the heat-generating elements 31 required to be applied with heat energy and the heat-generating elements 31 not required to be applied with heat energy based on formation pattern data of the bores 15 previously input through the operation part 48, and the CPU 45 causes the RAM 47 to store the classification as application data. Then, based on the stored application data, the CPU 45 causes heat energy to be applied only to the heat-generating elements 31 required to be applied with heat energy to form a plurality of perforation lines L.

At this time, in the case where it is necessary to apply heat energy to the same heat-generating elements 31 continuously, the control part 40 causes high heat energy to be applied to only the heat-generating elements 31 concerned.

Further, in the case where heat energy is applied to the same heat-generating elements 31 in at least three lines continuously, the control part 40 causes high heat energy applied to the heat-generating elements 31 in the second line to be applied to the heat-generating elements 31 in the third and subsequent lines continuously.

Further, in the case where the application of heat energy to the heat-generating elements 31 to which high heat energy has been applied is stopped once, and thereafter the application of heat energy is restarted with respect to the heat-generating elements 31 when the subsequent perforation lines L are formed, the control part 40 causes heat energy applied initially to be applied to the heat-generating elements 31.

In addition, the control part 40 of this embodiment is set so as to calculate a change in temperature characteristics of the thermal head 30 based on the temperature of the thermal head 30 detected by the temperature detection sensor 63 and the number of heat-generating elements 31 to which heat energy is applied simultaneously and so as to apply heat energy to the heat-generating elements 31 while correcting the energy amount in accordance with the changed temperature characteristics.

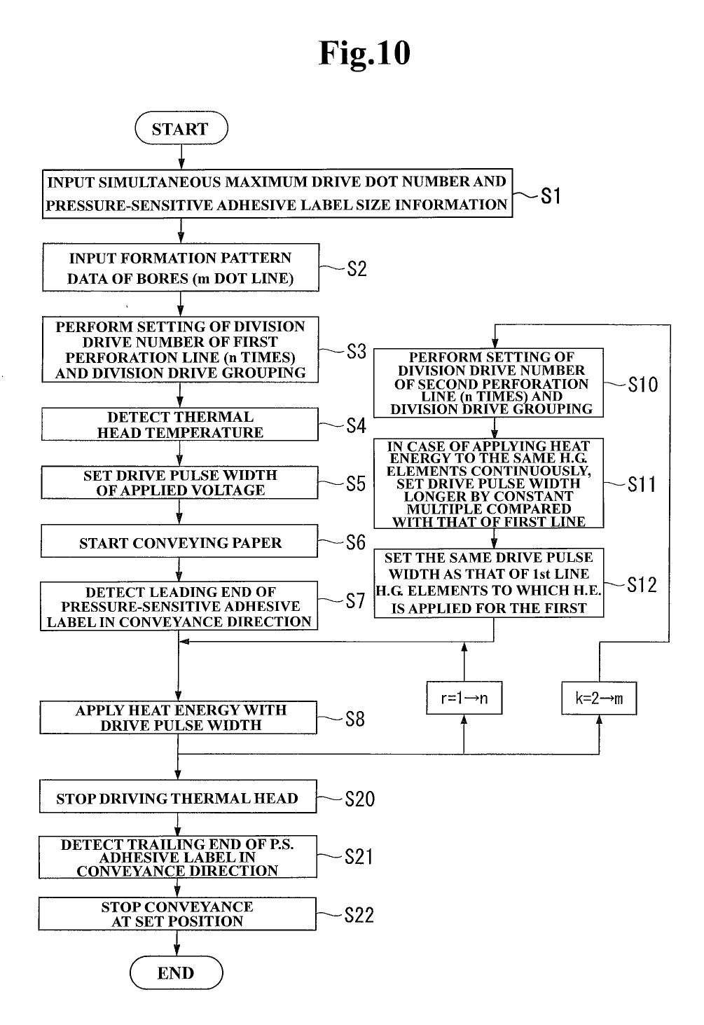

Next, the case of issuing the pressure-sensitive adhesive label 10 through use of the pressure-sensitive adhesive label issuing device 60 configured as described above is described with reference to a flowchart shown in FIG. 10.

First, the size information of the pressure-sensitive adhesive label 10 and the total number of the heat-generating elements 31 (maximum dot number of the heat-generating elements 31 to which heat energy can be applied simultaneously) of the thermal head 30 are input (S1) through the operation part 48, and formation pattern data (a number m of the perforation line L, etc.) of the bores 15 through which pressure-sensitive adhesive strength is exhibited is input (S2).

Then, the control part 40 causes the RAM 47 to store the input data and classifies the heat-generating elements 31 into those which are required to be applied with heat energy and those which are not required to be applied with heat energy for each of the perforation lines L, based on the formation pattern data, and the control part 40 causes the RAM 47 to store the classification as application data.

Next, for forming the first perforation line L (L1), the control part 40 grasps a ratio of the number of the heat-generating elements 31 required to be applied with heat energy to the stored total number of the heat-generating elements 31, based on the input data and the application data, and sets a division number at which heat energy is applied a plurality of times (n times) separately and groups the heat-generating elements (S3).

More specifically, in the case where the total number (total dot number) of the heat-generating elements 31 is, for example, 640, and the number of the heat-generating elements 31 required to be applied with heat energy is 320, when 320 heat-generating elements 31 corresponding to a half of the total number of the heat-generating elements 31 are applied with heat energy at once, the temperature of the thermal head 30 rises easily. Therefore, the 320 heat-generating elements 31 required to be applied with heat energy are divided into a plurality of groups so as to apply heat energy to each group. Further, the reduction in the number of the heat-generating elements 31 to be applied with heat energy simultaneously suppresses a peak current and also contributes to the alleviation of a burden on a power source.

Then, the control part 40 grasps the current temperature of the thermal head 30 based on the detection result from the temperature detection sensor 63 (S4). Then, the control part 40 sets a pulse width of an applied voltage based on the temperature of the thermal head 30 and the number of the heat-generating elements 31 in one of the above-mentioned groups (S5).

More specifically, the energy amount of heat energy to be applied is set based on the temperature of the thermal head 30 and the number of the heat-generating elements 31 to be applied with heat energy simultaneously.

Next, the control part 40 operates the first conveying rollers 21, the second conveying rollers 23, and the cutter drive part 26 so as to cut the label paper P to obtain the pressure-sensitive adhesive label 10, and conveys the pressure-sensitive adhesive label 10 to the pressure-sensitive adhesive strength exhibiting unit 24 (S6). Herein, when the first detection sensor 61 detects the leading end of the pressure-sensitive adhesive label 10 in the conveyance direction (S7), the control part 40 causes heat energy to be applied to the grouped heat-generating elements 31 of the heat-generating elements 31 of the thermal head 30 at the above-mentioned pulse width (S8). Then, the control part 40 repeats the application of heat energy n times, thereby applying the heat energy to the heat-generating elements 31 in all the groups.

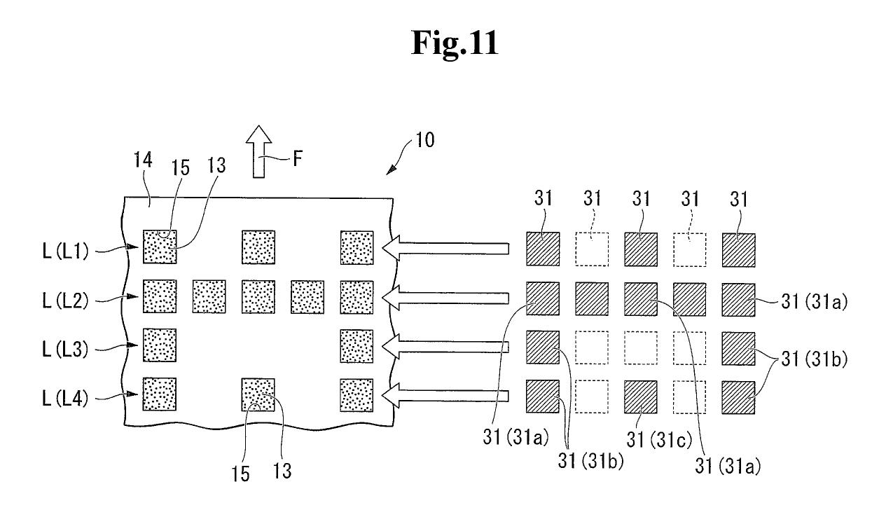

Accordingly, as illustrated in FIG. 11, the first perforation line L (L1) can be formed in the functional layer 14 of the pressure-sensitive adhesive label 10. FIG. 11 illustrates together the heat-generating elements 31 applied with a voltage of the heat-generating elements 31 of the thermal head 30. Further, dotted lines in FIG. 11 indicate the heat-generating elements 31 that have not been applied with a voltage.

When the formation of the first perforation line L (L1) is completed, the control part 40 grasps a ratio of the number of the heat-generating elements 31 required to be applied with heat energy with respect to the stored total number of the heat-generating elements 31 again based on the input data and the application data, for forming the second perforation line L (L2), and sets a division number at which heat energy is applied a plurality of times (n times) separately and groups the heat-generating elements 31 (S10).

In particular, when forming the first perforation line L (L1), the control part 40 groups the heat-generating elements 31 into a group in which the same heat-generating elements 31 are required to be applied with heat energy again continuously and a group in which the heat-generating elements are not applied with heat energy in the first line and are required to be applied with heat energy for the first time in the second line.

Next, the control part 40 sets the group in which the heat-generating elements 31 are required to be applied with heat energy again continuously so that the heat-generating elements 31 may be applied with heat energy at a pulse width which is several times (about 1.3 to 1.7 times) longer than that of the heat energy applied during formation of the first line (S11). More specifically, the control part 40 sets the group so that high heat energy with an increased energy amount may be applied to the heat-generating elements 31.

In contrast, the control part 40 sets the group in which the heat-generating elements 31 are not applied with heat energy in the first line and are required to be applied with heat energy in the second line so that heat energy may be applied to the heat-generating elements 31 at the same pulse width as that of the heat energy applied during formation of the first line (S12).

In any of the above-mentioned cases, the energy amount is corrected with temperature in accordance with the temperature of the thermal head 30 based on the detection result of the temperature detection sensor 63.

The control part 40 causes heat energy to be applied to the grouped heat-generating elements 31 at each of the above-mentioned pulse widths and repeats the application of heat energy n times, thereby applying the heat energy to the heat-generating elements 31 in all the groups (S8). Accordingly, as illustrated in FIG. 11, the second perforation line L (L2) can be formed in the functional layer 14 of the pressure-sensitive adhesive label 10.

By repeating the above-mentioned operation similarly, a plurality of perforation lines L (the third perforation line L (L3) and the fourth perforation line L (L4)) can be formed, and the bores 15 can be formed in accordance with the input formation pattern data of the bores 15 in the functional layer 14 of the pressure-sensitive adhesive label 10.

Then, after all the bores 15 are formed, the control part 40 stops the application of heat energy to the heat-generating elements 31 of the thermal head 30 (S20) and stops the drive of the platen roller 32 in response to the detection of the trailing end of the pressure-sensitive adhesive label 10 in the conveyance direction by the second detection sensor 62 (S21). The control part 40 stops the third conveying rollers 25 at a time when the pressure-sensitive adhesive label 10 has been conveyed to the set position on the front side F (S22).

Accordingly, the pressure-sensitive adhesive label 10 with pressure-sensitive adhesive strength exhibited by the bores 15 opened in accordance with the formation pattern data can be issued.

In particular, according to this embodiment, when the second and subsequent perforation lines L are formed, only in the case where the same heat-generating elements 31 are required to be applied with heat energy continuously, the heat-generating elements 31 are applied with high heat energy, instead of applying high heat energy to all the heat-generating elements 31 uniformly. (Specifically, only the heat-generating elements 31 (31a) illustrated in FIG. 11 are applied with high heat energy.) Thus, only the required heat-generating elements 31 can be applied with high heat energy, and hence, the rise in temperature of the thermal head 30 can be suppressed easily.

Further, in the case of applying heat energy to the same heat-generating elements 31 continuously, the control part 40 continuously applies high heat energy to the third and subsequent lines with the energy amount enhanced only once in the second line, instead of enhancing the energy amount gradually. (More specifically, high heat energy in the same energy amount as that in the second line is applied to the heat-generating elements 31 (31b) illustrated in FIG. 11.) Thus, the power consumption and the rise in temperature of the thermal head 30 can be easily suppressed effectively.

Even in this case, the bores 15 in the third and subsequent perforation lines L can be formed in a uniform bore shape corresponding to the heat-generating elements 31. More specifically, even when a part of the functional layer 14, for example, which is molten during the formation of the first perforation line L (L1) to adhere to the thermal head 30, overlaps the functional layer 14 at a position where bores in the second perforation line L (L2) are to be formed, that part is once heated and raised in temperature and hence is molten easily. Therefore, that part diffuses easily to the periphery of the bores 15 during the formation of the second perforation line L (L2), and does not easily adhere to the thermal head 30 again to overlap the functional layer 14 at a position where the third perforation line L (L3) is to be formed.

Accordingly, the film thickness of the functional layer 14 does not easily become larger gradually after the third line, and hence, the above-mentioned functional effect can be exhibited.

Further, when the third and subsequent perforation lines L are formed, the control part 40 once stops the application of heat energy to the heat-generating elements 31 to which high heat energy has been applied, and thereafter, applies initially applied heat energy to the heat-generating elements 31 in the case of applying the heat energy to the heat-generating elements 31 again. (More specifically, heat energy is applied to the heat-generating elements 31 (31c) illustrated in FIG. 11.)

In particular, the control part 40 once stops the application of heat energy to the heat-generating elements 31. Therefore, even when a part of the functional layer 14, which is molten, adheres to the thermal head 30, the application of heat energy is stopped, and hence, the part of the functional layer 14 is not dragged easily to a region of the functional layer 14 where the subsequent perforation lines L are formed. Thus, the bores 15 can be formed in the same state as that during the formation of the first perforation line L (L1), and the bores 15 can be formed in a uniform bore shape corresponding to the heat-generating elements 31 through use of the initially applied heat energy. In particular, the energy amount is returned to the original, and hence, power consumption can be further suppressed easily.

Further, the temperature of the thermal head 30 is detected by the temperature detection sensor 63, and heat energy is applied while the energy amount is corrected in accordance with the temperature characteristics of the thermal head 30 due to the heat storage effect. Therefore, heat energy in a more appropriate energy amount can be applied, and the bores 15 in a bore shape corresponding to the heat-generating elements 31 can be formed more stably.

Further, although the temperature characteristics of the thermal head 30 also change due to the heat storage effect depending on the number of heat-generating elements 31 to which heat energy is applied simultaneously, the present invention is also applicable to this case.

### Third Embodiment

Next, a third embodiment according to the present invention is described. In the third embodiment, the same constituent elements as those in the second embodiment are denoted with the same reference symbols as those therein and the descriptions thereof are omitted.

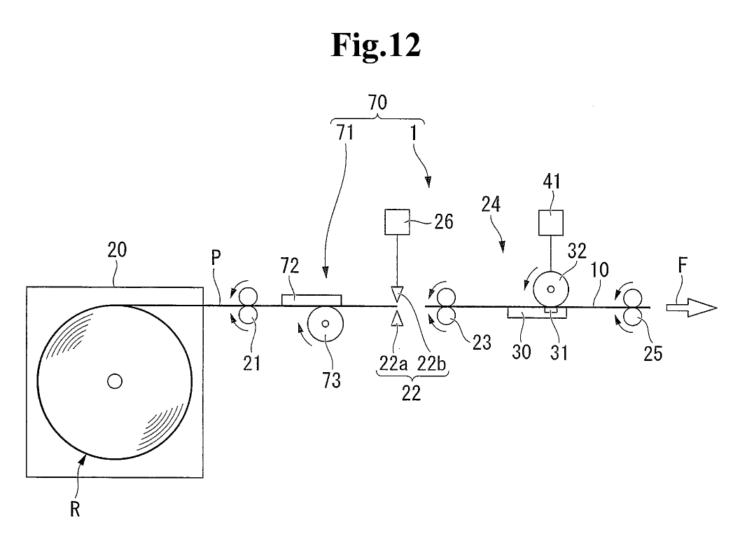

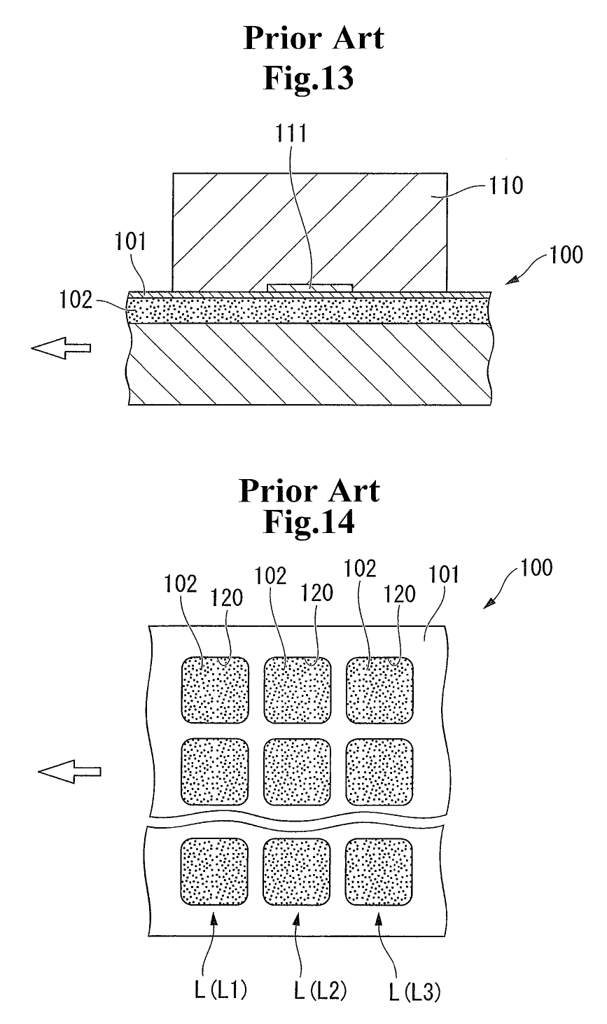

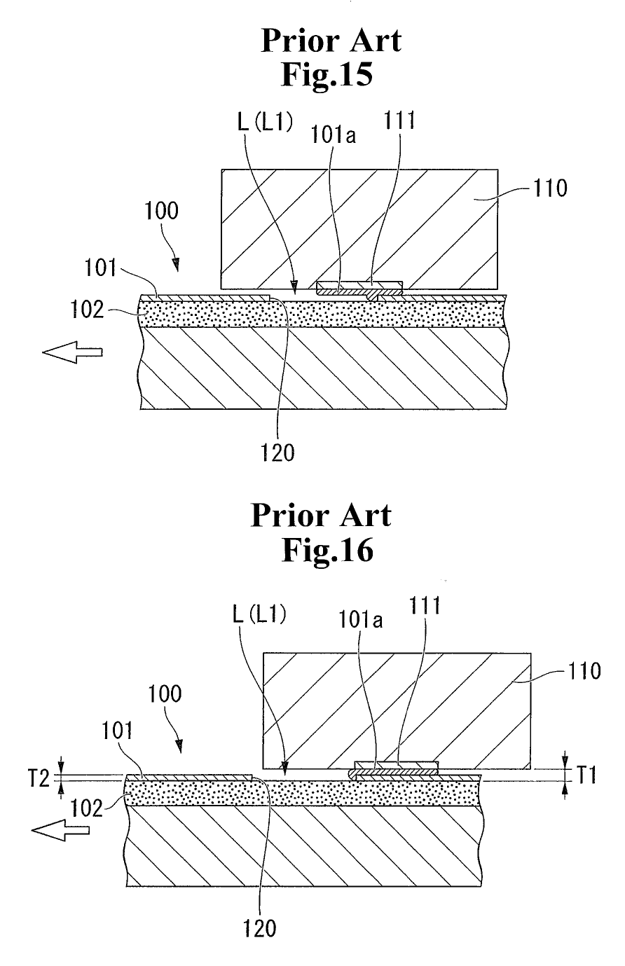

As illustrated in FIG. 12, a printer 70 of this embodiment includes the pressure-sensitive adhesive label issuing device 1 and a printing unit 71 for printing on the printable layer 12, which is placed on a upstream side of the first conveying rollers 21 in the conveyance direction.

The printing unit 71 includes a printing thermal head 72 for printing on the printable layer 12 of the label paper P by heating the printable layer 12 to cause the printable layer 12 to develop color, in which heat-generating elements (not shown) are aligned in a row, and a printing platen roller 73 for conveying the label paper P to the front side F while sandwiching the label paper P between the printing thermal head 72 and the printing platen roller 73.

The printing thermal head 72 and the printing platen roller 73 have configurations similar to those of the thermal head 30 and the platen roller 32 of the pressure-sensitive adhesive strength exhibiting unit 24, and the operations of the printing thermal head 72 and the printing platen roller 73 are controlled by the CPU 45.

The printer 70 thus configured can print desired information on the printable layer 12 stably before causing the pressure-sensitive adhesive strength exhibiting unit 24 to exhibit pressure-sensitive adhesive strength. Therefore, the pressure-sensitive adhesive label 10 of high quality can be obtained, in which various kinds of pieces of information are printed clearly and stable pressure-sensitive adhesive strength is exhibited.

In this embodiment, the printing unit 71 needs to be placed on an upstream side of the pressure-sensitive adhesive strength exhibiting unit 24 in the conveyance direction and may be placed, for example, between the cutter unit 22 and the pressure-sensitive adhesive strength exhibiting unit 24.

Note that, the technical scope of the present invention is not limited to the above-mentioned embodiments, but various modifications can be made without departing from the spirit of the present invention.

What is claimed is:

1. A pressure-sensitive adhesive strength exhibiting unit for heating a pressure-sensitive adhesive label to cause the pressure-sensitive adhesive label to exhibit pressure-sensitive adhesive strength, the pressure-sensitive adhesive label including a printable layer provided on one surface of a base and a pressure-sensitive adhesive layer covered with a non-pressure-sensitive-adhesive functional layer and provided on another surface of the base, the pressure-sensitive adhesive strength exhibiting unit comprising:
a thermal head including a plurality of heat-generating elements aligned in a row, for heating the pressure-sensitive adhesive label from the pressure-sensitive adhesive layer side to cause each of the plurality of heat-generating elements to form a bore in the non-pressure-sensitive-adhesive functional layer;
a platen roller for conveying the pressure-sensitive adhesive label while sandwiching the pressure-sensitive adhesive label between the thermal head and the platen roller; and
a control part for applying heat energy to each of the plurality of heat-generating elements independently to control heat generation,
wherein, when the control part continuously forms a plurality of perforation lines in which a plurality of the bores are aligned in a row by repeating the application of heat energy, the control part applies high heat energy, whose energy amount is higher than an energy amount of heat energy applied to the heat-generating elements during formation of a previous perforation line, to the heat-generating elements to form the perforation line.

2. A pressure-sensitive adhesive strength exhibiting unit according to claim 1, wherein, for forming the plurality of the perforation lines, in a case where it is necessary to apply the heat energy continuously to the same heat-generating elements, the control part applies the high heat energy only to the heat-generating elements concerned.

3. A pressure-sensitive adhesive strength exhibiting unit according to claim 1, wherein, for forming the plurality of the perforation lines, in a case where the application of heat energy to the heat-generating elements to which the high heat energy has been applied is stopped once, and thereafter the application of heat energy to the heat-generating elements is restarted during formation of a subsequent perforation line, the control part applies the initially applied heat energy to the heat-generating elements.

4. A pressure-sensitive adhesive strength exhibiting unit according to claim 1, wherein the high heat energy is higher than and twice or less the energy amount of the initially applied heat energy.

5. A pressure-sensitive adhesive strength exhibiting unit according to claim 1, wherein the control part enhances an energy amount by increasing a pulse width of an applied voltage compared with a pulse width during the application of the heat energy, and applies the heat energy with the enhanced energy amount as the high heat energy.

6. A pressure-sensitive adhesive strength exhibiting unit according to claim 1, wherein the control part performs the application of heat energy periodically so that a plurality of the perforation lines are aligned continuously at a narrow pitch equal to or less than a pitch between the heat-generating elements.

7. A pressure-sensitive adhesive strength exhibiting unit according to claim 1, further comprising a temperature detection sensor for detecting a temperature of the thermal head,
wherein the control part calculates a change in temperature characteristics of the thermal head based on the temperature detected by the temperature detection sensor, and performs the application of heat energy while correcting an energy amount in accordance with the changed temperature characteristics.

8. A pressure-sensitive adhesive strength exhibiting unit according to claim 1, wherein the control part calculates a change in temperature characteristics of the thermal head based on a number of the heat-generating elements to which the application of heat energy is performed simultaneously, and performs the application of heat energy while correcting an energy amount in accordance with the changed temperature characteristics.

9. A pressure-sensitive adhesive label issuing device, comprising:
the pressure-sensitive adhesive strength exhibiting unit according to claim 1; and
a cutter unit placed on an upstream side of the pressure-sensitive adhesive strength exhibiting unit in a conveyance direction, for cutting band-shaped label paper to a predetermined length and transferring the cut label paper to the pressure-sensitive adhesive strength exhibiting unit as the pressure-sensitive adhesive label.

10. A printer, comprising:
the pressure-sensitive adhesive label issuing device according to claim 1; and
a printing unit placed on an upstream side of the pressure-sensitive adhesive strength exhibiting unit in the conveyance direction, for printing on the printable layer.

11. A pressure-sensitive adhesive strength exhibiting unit according to claim 2, wherein, in a case where the heat energy is applied to the same heat-generating elements continuously in at least three lines, the control part continuously applies the high heat energy, which has been applied to a second line, in third and subsequent lines.

12. A pressure-sensitive adhesive strength exhibiting unit according to claim 11, wherein, for forming the plurality of the perforation lines, in a case where the application of heat energy to the heat-generating elements to which the high heat energy has been applied is stopped once, and thereafter the application of heat energy to the heat-generating elements is restarted during formation of a subsequent perforation line, the control part applies the initially applied heat energy to the heat-generating elements.

13. A pressure-sensitive adhesive strength exhibiting unit according to claim 12, wherein the high heat energy is higher than and twice or less the energy amount of the initially applied heat energy.

14. A pressure-sensitive adhesive strength exhibiting unit according to claim 13, wherein the control part enhances an energy amount by increasing a pulse width of an applied voltage compared with a pulse width during the application of the heat energy, and applies the heat energy with the enhanced energy amount as the high heat energy.

15. A pressure-sensitive adhesive strength exhibiting unit according to claim 14, wherein the control part performs the application of heat energy periodically so that a plurality of the perforation lines are aligned continuously at a narrow pitch equal to or less than a pitch between the heat-generating elements.

16. A pressure-sensitive adhesive strength exhibiting unit according to claim 15, further comprising a temperature detection sensor for detecting a temperature of the thermal head,
wherein the control part calculates a change in temperature characteristics of the thermal head based on the temperature detected by the temperature detection sensor, and performs the application of heat energy while correcting an energy amount in accordance with the changed temperature characteristics.

17. A pressure-sensitive adhesive strength exhibiting unit according to claim 16, wherein the control part calculates a change in temperature characteristics of the thermal head based on a number of the heat-generating elements to which the application of heat energy is performed simultaneously, and performs the application of heat energy while correcting an energy amount in accordance with the changed temperature characteristics.

18. A pressure-sensitive adhesive label issuing device, comprising:
the pressure-sensitive adhesive strength exhibiting unit according to claim 17; and
a cutter unit placed on an upstream side of the pressure-sensitive adhesive strength exhibiting unit in a conveyance direction, for cutting band-shaped label paper to a predetermined length and transferring the cut label paper to the pressure-sensitive adhesive strength exhibiting unit as the pressure-sensitive adhesive label.

19. A printer, comprising:
the pressure-sensitive adhesive label issuing device according to claim 18; and
a printing unit placed on an upstream side of the pressure-sensitive adhesive strength exhibiting unit in the conveyance direction, for printing on the printable layer.
